(19) United States
(12) Patent Application Publication
(10) Pub. No.: US 2014/0318654 A1
(43) Pub. Date: Oct. 30, 2014

(54) Supply of fluid for a recreational vehicle

(71) Applicant: Royce Rasmussen, Sullivan, IL (US)

(72) Inventor: Royce Rasmussen, Sullivan, IL (US)

(21) Appl. No.: 13/872,083

(22) Filed: Apr. 27, 2013

(51) Int. Cl. B60R 16/08

(52) U.S. Cl. CPC B60R 16/08
USPC 137/899

(57) ABSTRACT

An auxiliary fluid supply for a vehicle may include a rigid container including a cavity, and a flexible container is positioned within the cavity to supply the fluid to the vehicle. The flexible container may be filled with a fluid, and the rigid container may be pressurized to compress the flexible container to supply the fluid to the vehicle. The flexible container may be connected to a valve pressure regulator. The flexible container may be connected to a fluid supply source. The rigid container may be connected to a pressure generator.

### FIELD OF THE INVENTION

The present invention relates to a supply of fluid such as water and more particularly to a supply of fluid for a recreational vehicle (RV) or other type of vehicle

### BACKGROUND

When a recreational vehicle is being stowed at the owner's residence or being parked at facility for the use of these recreational vehicles, generally there is a supply of pressurized fresh water which may be directly connected to the plumbing system of the recreational vehicle. Under these circumstances, the recreational vehicle does not require a secondary source of pressurized fresh water.

However, frequently the recreational vehicle may be used under circumstances where there is no source of pressurized fresh water. Under the circumstances, water may be obtained from a supply tank. However, there is a need to pressurize the water for the plumbing system of the recreational vehicle. Furthermore, there is a need to be able to adjust the pressure.

U.S. Pat. No. 4,182,371 discloses an automatically actuated liquid flow control device or valve which serves to start or stop the flow of a liquid, e.g., water, through a supply line at a desired time or, in the case of stopping the flow of a liquid, after a predetermined amount of liquid has passed through the valve. The liquid flow control valve includes an expandable balloon-like bladder or reservoir. The automatic liquid flow control valve is particularly adapted for use in conjunction with lawn or garden watering systems. U.S. Pat. No. 4,744,385 discloses a system being especially useful in recreational vehicles but is obviously adaptable to other arrangements. As obviously applied to a recreational vehicle (RV) having a fresh water tank, a grey tank and a waste tank, the system includes a plurality of electrically activated valves, one for each tank, so arranged as to be individually operated exclusive of each other in a convenient sequence for filling the water tank, draining and rinsing the grey tank and finally draining and rinsing the waste tank. The grey and waste tanks are connected to a water supply line by separate lines, each of which includes spray nozzles assuring cleansing of the tanks. A pump is provided in conjunction with the water for use in the event of a situation in which an external water source—such as city water—is not available.

U.S. Pat. No. 4,974,899 discloses a body of a recreational vehicle (RV) being configured to have a stowage compartment within the body's interior but separate from the interior occupant space. The stowage compartment contains a tank which serves water use fixtures in the interior occupant space. The stowage compartment is disposed adjacent the sidewall of the RV body and an opening is provided through the sidewall from the stowage space to the exterior. This opening is closed by a door. When the door is open, the tank can pass through the opening into and out of the stowage space. The tank can be either a fresh water tank containing a supply of fresh water for use at sanitary fixtures in the RV or alternatively it can be a waste water tank of either the gray water or black water type which collects waste from the water use fixtures.

U.S. Pat. No. 5,911,406 discloses a combined liquid dispensing and item storage system with an orally activated valve. The system comprises a collapsible container for liquid that incorporates integrated auxiliary expandable storage pockets. The system is removably secured at a location on the back between the shoulders. An externally accessible fill port is covered by a flexible embossed foam panel held in place by shoulder straps and which panel protects against the discomfort of the fill port cap against the back, insulates the liquid, and provides air channels to vent and dissipate body heat. A length of flexible tubing for delivering the liquid is attached to the collapsible container, then routed through a slot in the auxiliary expandable storage pocket, over either shoulder, and held near the mouth by adjustable orienting holders attached to the shoulder straps. The orally activated valve is located at the end of the flexible tubing which delivers the liquid from the flexible tubing to the mouth. The valve device is in the form of an elongated hollow structure having an open inlet end opposed to a closed outlet end forming a fluid supply chamber between the open inlet and closed outlet end. The open inlet end is connected to the flexible tubing in order to obtain liquid from the collapsible container for the supply chamber. The closed outlet end embodies a spring biased valve plunger which can be depressed by tongue or teeth to move the valve plunger into an open configuration to enable liquid flow therethrough.

U.S. Pat. No. 5,984,199 discloses an improved backpack sprayer, comprising a supply tank, an expandable accumulator, a pump mechanism, an intake valve, a discharge valve, and a spray wand with a nozzle. The supply tank is designed to hold fluids, such as insecticides, herbicides, water sealants, etc. The expandable accumulator is preferably an elastomeric bladder, the function of which is to accumulate fluid from the supply tank under pressure. The volume of the bladder expands as pressurized fluid enters from the pump mechanism. As with most backpack sprayers, the pump mechanism is positioned adjacent to the bottom of the supply tank and is in fluid communication with the tank. The function of the pump mechanism is to pump fluid from the supply tank into the bladder. An intake valve, associated with an inlet opening of the bladder, enables a unidirectional flow of liquid from the pump to the bladder. Discharge of fluid from the bladder also occurs through the inlet opening upon the opening of a discharge valve. The discharge valve is normally closed to permit the bladder to accumulate a desired quantity of fluid. In the preferred embodiment, the discharge valve is hand-operated and located in a handle attached to a spray wand and nozzle. When the discharge valve is opened, the discharged fluid is directed from the accumulator and channeled through a hose, trigger handle, spray wand and spray nozzle.

U.S. Pat. No. 6,131,595 discloses a valve body being formed in two half sections which are secured together to define a water passage and to confine therebetween a thin gate valve blade for movement between a lower open position and an upper closed position. An actuator includes a flexible bellows sealed to the valve body above the passage and a top plate connected by a rod to the valve blade. The valve body and the bellows define an expandable fluid chamber connected by a bottom port or line to a drain line. The valve body is installed within a water supply line or a sewage drain line extending under a floor. In the event sewage water backs up within the drain line, air within the fluid chamber is compressed to expand the bellows upwardly for closing the valve. When the sewage water flows from the drain line, the air pressure reduces, and the bellows collapses and automatically returns the valve blade to its open position.

U.S. Pat. No. 6,857,583 discloses a boat or recreational vehicle (RV) mounted pressure washing system fully plumbed and integrated electrically with the boat or RV, and located remotely therewithin according to user's preferred mounting location such as the bilge, engine compartment or a supply cabinet. The system provides the user with a high pressure supply of water for washing, rinsing, etc. by means of a pump, water reservoir and fully retractably high pressure hose, to which a nozzle of choice may be quickly attached or removed when not in use. The pressure hose is of significant length to provide for the pressure washing of the entire vehicle and surrounding areas by the user, whereby when not in use is fully retractable into the boat or RV for storage.

U.S. Pat. No. 6,907,622 discloses a flushing device for toilets including a source for applying a fluid pressure to a blockage area and provides a seal in the blocked conduit to prevent backflow so that full pressure is applied to the blockage. The device includes a resilient, deformable and expandable element secured at the end of a tubular member which is inserted into a toilet conduit leading to the drain line. The tubular member has a coupling at its end opposite to the end carrying the expandable element to which a hose is connected in order to alternately supply pressurized water to the element or to the conduit. The expandable element is carried on a linear portion of the tubular member adjacent to the discharge orifice thereof and is expanded into a sealing condition with the conduit entrance leading into the drain line. The exterior surface of the expandable element is provided with spaced-apart ridges and grooves that are deformable to provide a positive sealing relationship with the entrance of the conduit so as to completely seal the entrance. A valve mechanism is disposed between the tubular member and a pipe connected to the element for user selection of fluid supply to either the element or to the drain conduit.

### SUMMARY

An auxiliary fluid supply for a vehicle may include a rigid container including a cavity, and a flexible container is positioned within the cavity to supply the fluid to the vehicle.

The flexible container may be filled with a fluid, and the rigid container may be pressurized to compress the flexible container to supply the fluid to the vehicle.

The flexible container may be connected to a valve pressure regulator.

The flexible container may be connected to a fluid supply source.

The rigid container may be connected to a pressure generator.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a schematic view of the fluid supply device of the present invention;

FIG. 2 illustrates a front view of the rigid container and the flexible container of the present invention;

FIG. 3 illustrates a back view of the rigid container and the flexible container of the present invention;

FIG. 4 illustrates a side view in a first position of the rigid container and the flexible container of the present invention;

FIG. 5 illustrates another side view in a second position of the rigid container and the flexible container of the present invention.

### DETAILED DESCRIPTION

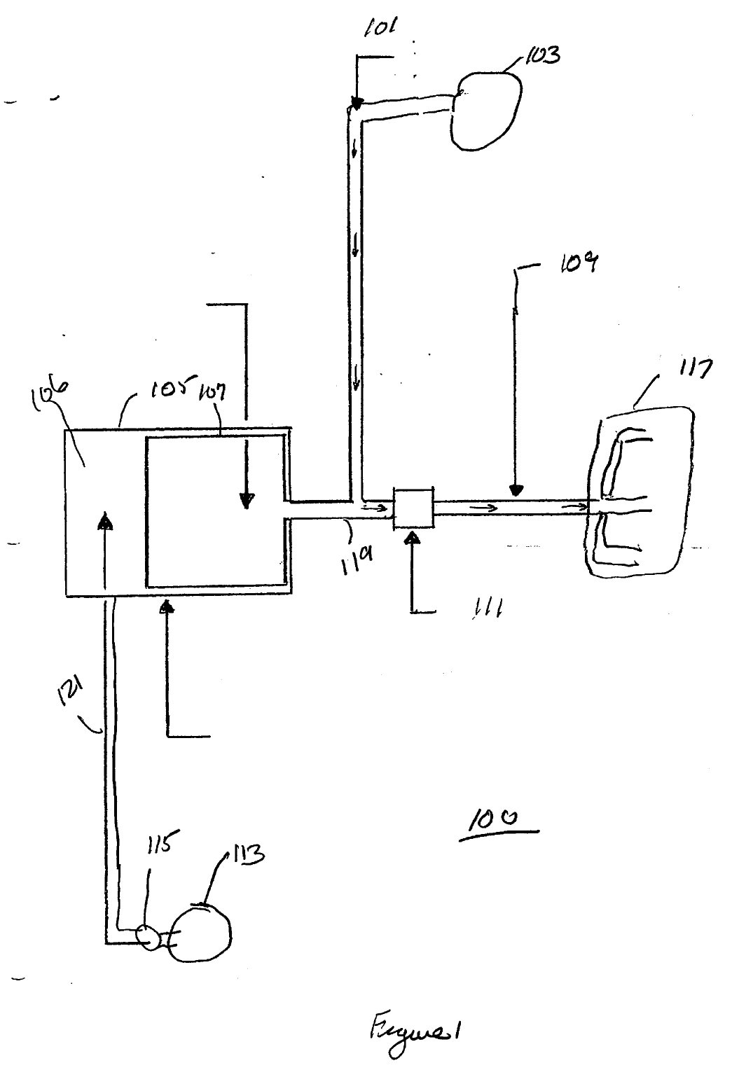

FIG. 1 illustrates a schematic view of the fluid supply device 100 of the present invention. The fluid supply device 100 of the present invention provides pressurized fluid which may be water to a plumbing system 117 of the vehicle such as a recreational vehicle (RV).

The fluid supply device 100 of the present invention may provide the pressurized fluid from an external supply such as a fluid (water) supply source 103 when the external supply is available to be connected to the fluid supply source 103. The fluid supply source 103 may be connected to a first fluid passageway 101 which may be rigid tubing or flexible tubing which may be connected to a second fluid passageway 119. The second fluid passageway 119 may be rigid tubing or flexible tubing and may be connected to the flexible interior container 107 which may be an expandable bladder which may be compressible and expandable. The second fluid passageway 119 may be connected to a valve regulator 111. The fluid may flow from the fluid supply source 103 through the first fluid passageway 101 and through the second fluid passageway 119 to the flexible interior container 107 to fill the flexible interior container 107 with fluid to be used at a later time. Alternatively, the fluid may flow from the fluid supply source 103 through the first fluid passageway 101 and through the second fluid passageway 119 to the input of the valve regulator 111. The valve pressure regulator 111 may be manually controlled or electronically controlled to adjust the flow and pressure of fluid through the valve pressure regulator 111. The output of the valve pressure regulator 111 may be connected to the third fluid passageway 109 which may connect to the plumbing system 117 of the vehicle which may be a recreational vehicle.

Fluid may flow from the fluid supply source 103 through the first fluid passageway 101 and then flow through the second fluid passageway 119. The fluid may flow through the valve pressure regulator 111 and the pressure may be reduced or raised by the operation of the valve pressure regulator 111. The fluid may flow out of the valve pressure regulator 111 and flow through the third fluid passageway 109 to the plumbing system 117 of the vehicle.

FIG. 1 additionally illustrates a rigid container 105 which may be hollow and pressurized to expand or compress a flexible interior container 107. The flexible interior container 107 may be connected to the second fluid passageway 119 so that the flexible interior container 107 may be filled with fluid from the fluid supply source 103 when the pressure within the rigid container 105 is at a first predetermined level which may be a low pressure level. Furthermore the flexible interior container 107 may be compressed by the pressure within the rigid container 105 to release the fluid from the flexible interior container 107, and the released fluid may flow through the second fluid passageway 119 and through the valve pressure regulator 111 to supply fluid which may be water to the plumbing system 117 of the vehicle.

The rigid container 105 may be pressurized by either gas or fluid by a pressure generator 113 which may be controlled by a pressure regulator 115 to regulate the pressure between the first predetermined level which may be a low-pressure and a second predetermined level which may be a high-pressure.

FIG. 2 illustrates a front view of the rigid container 105 which may include a front wall 131 which may be connected to a top wall 133 which may be connected to a pair of opposing side walls 135 and which may be connected to a back wall 137. The side walls 135, the front wall 131 and the back wall 137 may be connected to a bottom wall 139. FIG. 2 illustrates the fourth passageway 121 and the second fluid passageway 119. The front wall 131, the back wall 137, the top wall 133 and the side walls 135 define a cavity 106 for the flexible container.

FIG. 2 additionally illustrates a front view of the flexible container 107 which may include a flexible front wall 141 which may be connected to a flexible top wall 143 which may be connected to a pair of opposing flexible side walls 145 and which may be connected to a flexible back wall 147. The flexible side walls 145, the flexible front wall 141 and the flexible back wall 147 may be connected to a bottom wall 149.

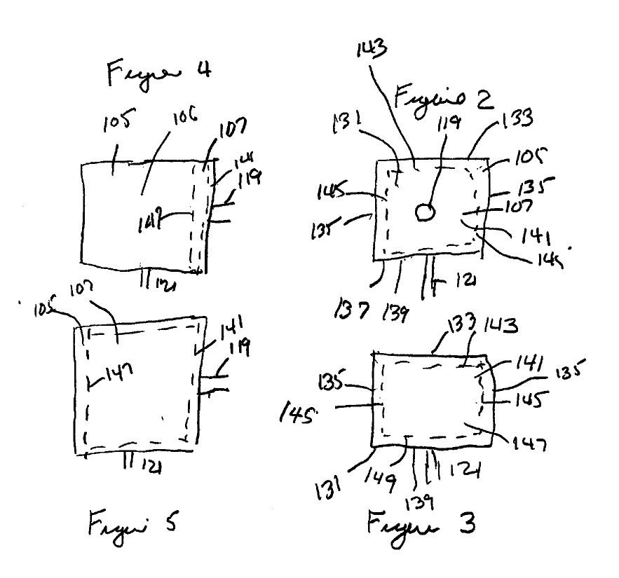

FIG. 3 illustrates a front view of the rigid container 105 which may include a front wall 131 which may be connected to a top wall 133 which may be connected to a pair of opposing side walls 135 and which may be connected to a back wall 137. The side walls 135, the front wall 131 and the back wall 137 may be connected to a bottom wall 139. FIG. 2 illustrates the fourth passageway 121 and the second fluid passageway 119.

FIG. 3 additionally illustrates a back view of the flexible container 107 which may include a flexible front wall 141 which may be connected to a flexible top wall 143 which may be connected to a pair of opposing flexible side walls 145 and which may be connected to a flexible back wall 147. The flexible side walls 145, the flexible front wall 141 and the flexible back wall 147 may be connected to a bottom wall 149.

FIG. 5 illustrates a side view of the rigid container 105 and the flexible interior container 107 in a first position where the flexible container 107 is substantially filled with fluid and being substantially uncompressed. The front wall 141 and the back wall 147 are in a spaced relationship.

FIG. 4 illustrates a side view of the rigid container 105 and may flexible interior container 107 and a second position where the flexible container 107 is substantially empty of fluid and being substantially compressed. The front wall 141 and the back wall 147 and moved together.

The first predetermined level may allow the flexible container 107 to fill with fluid from the fluid supply source 103. When the fluid from the flexible container 107 is required by the user, the pressure generator 113 increases the pressure of the fluid and the pressure is transferred to the rigid container 105 by the passageway 121. The pressure from the rigid container 105 compresses the flexible container 107 and forces the fluid within the flexible container 107 to flow through the second fluid passageway 119, through the valve pressure regulator 111 then through the third fluid passageway 109 to the plumbing system 117 of the vehicle.

As a result, the user of the vehicle may have a constant supply of fluid which may be water for the plumbing system 117 regardless of being connected to an external supply of water or not.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. An auxiliary fluid supply for a vehicle, comprising:
a rigid container including a cavity;
a flexible container is positioned within the cavity to supply the fluid to the vehicle;
wherein the flexible container is filled with a fluid and wherein the rigid container is pressurized to compress the flexible container to supply the fluid to the vehicle.

2. An auxiliary fluid supply for a vehicle as in claim 1, wherein the flexible container is connected to a valve pressure regulator.

3. An auxiliary fluid supply for a vehicle as in claim 1, wherein the flexible container is connected to a fluid supply source.

4. An auxiliary fluid supply for a vehicle as in claim 1, wherein the rigid container is connected to a pressure generator.
